(19) United States
(12) Patent Application Publication
(10) Pub. No.: US 2005/0205753 A1
(43) Pub. Date: Sep. 22, 2005

(54) Construction components including hinged portions and pliant sealing edges

(76) Inventor: Kyozaburo Takagi, Centerville, OH (US)

Correspondence Address: DINSMORE & SHOHL LLP;One Dayton Centre, Suite 1300, One South Main Street, Dayton, OH, 45402-2023, US

(21) Appl. No.: 11/056,943

(22) Filed: Feb. 11, 2005

Related U.S. Application Data
(60) Provisional application No. 60/544,096, filed on Feb. 12, 2004.
(60) Provisional application No. 60/544,184, filed on Feb. 12, 2004.

(51) Int. Cl. E04G 17/00; B29C 33/76

(52) U.S. Cl. 249/210; 249/183; 249/185

(57) ABSTRACT

A construction component is provided comprising a set portion, a hinged portion, and a hinge. The construction component defines an extruded cross-sectional profile defining a panel forming face configured such that an un-cured material may be cured against and subsequently released from the panel forming face in a substantially unobstructed manner. The hinge couples the set portion and the hinged portion such that the hinged portion is movable about the hinge between an engaged state and a disengaged state. The set portion and the hinged portion cooperate to define at least a portion of the panel forming face. The component can be configured such that movement of the hinged portion from the engaged state to the disengaged state reveals a component securing surface of the construction component.

### CROSS-REFERENCE TO RELATED APPLICATIONS

This application claims the benefit of U.S. Provisional Application Ser. Nos. 60/544,096 (FUU 0040 MA), filed Feb. 12, 2004, and 60/544,184 (FUU 0041 MA), filed Feb. 12, 2004.

### BACKGROUND OF THE INVENTION

The present invention relates to tilt-up, precast, cast-in-place, and other similar construction techniques where un-cured material, e.g., concrete, is introduced into a form and cured to assume the shape of the form. More particularly, the present invention relates to the configuration of the form and other construction components utilized with the form to supplement to the basic shape defined by the form. Examples of such components include form bulkheads, rustications or reveals, single chamfers, double chamfers, rounded chamfers, angled chamfers, rounded corner pieces, single and multi-component recess chamfers used at the edges of window and door openings, drip edge chamfers, and any other construction component configured to alter the cured shape of the material introduced into the form. The specific manner in which particular forms are constructed, the steps involved in introducing un-cured material into the form, and the steps associated with utilizing cured objects are beyond the scope of the present invention and can be readily gleaned from the art, including the published patent documents incorporated by reference herein.

Construction components according to the present invention may abut or be otherwise arranged upon an interior surface of a form to alter the interior boundaries of the form. Where the particular form at issue is configured upon a panel forming surface, such as a concrete panel forming slab, construction components according to the present invention may abut a surface of the panel forming slab bounded by the form, an interior surface of the form, or both the slab and the form.

### BRIEF SUMMARY OF THE INVENTION

In accordance with one embodiment of the present invention, a construction component is provided comprising a set portion, a hinged portion, and a hinge. The construction component defines an extruded cross-sectional profile defining a panel forming face configured such that an un-cured material may be cured against and subsequently released from the panel forming face in a substantially unobstructed manner. The hinge couples the set portion and the hinged portion such that the hinged portion is movable about the hinge between an engaged state and a disengaged state. The set portion and the hinged portion cooperate to define at least a portion of the panel forming face. The component can be configured such that movement of the hinged portion from the engaged state to the disengaged state reveals a component securing surface of the construction component.

In accordance with another embodiment of the present invention, the construction component is provided with pliant sealing edges extending along the longitudinal dimension of the construction component.

In accordance with another embodiment of the present invention, the construction component is provided as part of a panel forming system such that an un-cured material can be contained within respective panel forming sections of the panel forming system in the shape of a panel.

Accordingly, it is an object of the present invention to provide for improvements in tilt-up, precast, cast-in-place, and other similar construction techniques where un-cured material, e.g., concrete, is introduced into a form and cured to assume the shape of the form. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is an illustration of a panel forming system including construction components according to the present invention;

FIGS. 2A and 2B are cross-sectional illustrations of a construction component according to the present invention configured as a rustication configured to define a decorative strip in panels cured within a panel forming section of a panel form;

FIG. 3 is a cross-sectional illustration of a construction component according to the present invention configured as another type of rustication;

FIGS. 4A and 4B are cross-sectional illustrations of a construction component according to the present invention configured as yet another type of rustication;

FIG. 5 is a cross sectional illustration of a construction component according to the present invention configured as an additional type of rustication; and

FIG. 6 is a cross sectional illustration of a construction component according to the present invention configured as a corner chamfer.

### DETAILED DESCRIPTION

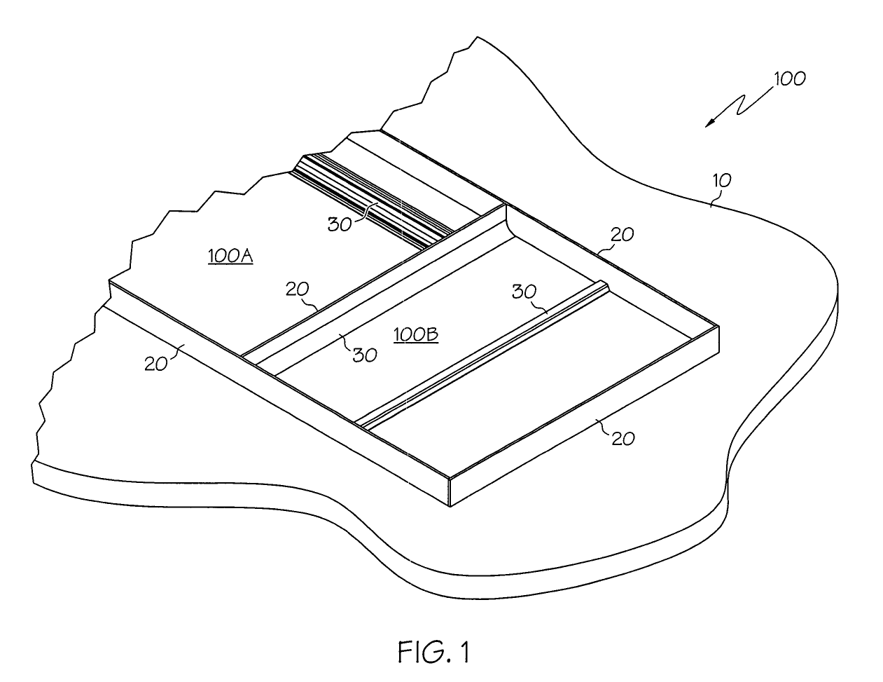

Construction components according to the present invention can be utilized in a variety of contexts. Referring specifically to FIG. 1, a panel forming system 100 is illustrated and comprises a panel forming slab 10 and a plurality of panel forming bulkheads 20 arranged such that an un-cured material, e.g., concrete, can be introduced and contained within individual panel forming sections 100A, B, etc., of the system 100 in the shape of respective panels. Individual construction components 30 are included in each panel forming section 100A, B as a supplement to the remaining components of the panel forming system 100 and are configured to further define the shape of respective panels cured within the sections 100A, B.

Each of the various construction components 30 according to the present invention comprises some type of supplemental panel form and can be configured to serve a variety of functions. For example, and not by way of limitation, construction components 30 according to the present invention may comprise corner chamfer positioned at the intersection of a bulkhead 20 and the panel forming slab 10, a double chamfer positioned to receive and support a bulkhead 20 defining the partition between adjacent panel forming sections 100A, 100B of the panel forming system 100, a rustication positioned to define a decorative strip in panels cured within the panel forming sections 100A, 100B, a drip edge form positioned to define drainage features in a cured panel, or any other conventional or yet to be developed supplemental panel form where the features of the present invention may find utility.

Referring collectively to the construction components 30 illustrated in the accompanying drawings, components according to the present invention comprise a set portion 32, a hinged portion 34, and a hinge 36, and generally define an extruded cross-sectional profile. The set portion 32 and the hinged portion 34 of the extruded cross-sectional profile cooperate to define at least a portion of a panel forming face 35 configured such that an un-cured material may be cured against and subsequently released from the panel forming face 35 in a substantially unobstructed manner. In this manner, the construction components 30 are left in the respective panel forming sections 100A, B when a cured panel is removed there from. It is contemplated that panel forming faces according to the present invention may take a variety of forms including, but not limited to, those illustrated in the accompanying drawings.

For the purposes of defining and describing the present invention it is noted that a component that defines an extruded cross sectional profile defines a substantially uniform cross section that extends along substantially the entire length of the component. It is contemplated that bodies defining an extruded cross sectional profile may, to a limited extent, embody variations in the uniformity of the cross section due to fabrication process errors or post fabrication process steps. For example, holes may be drilled in an extruded member in specific locations after the member is extruded. Similarly, cuts or cutouts may be formed in the extruded member or the extruded member may be bent or deformed after it is extruded.

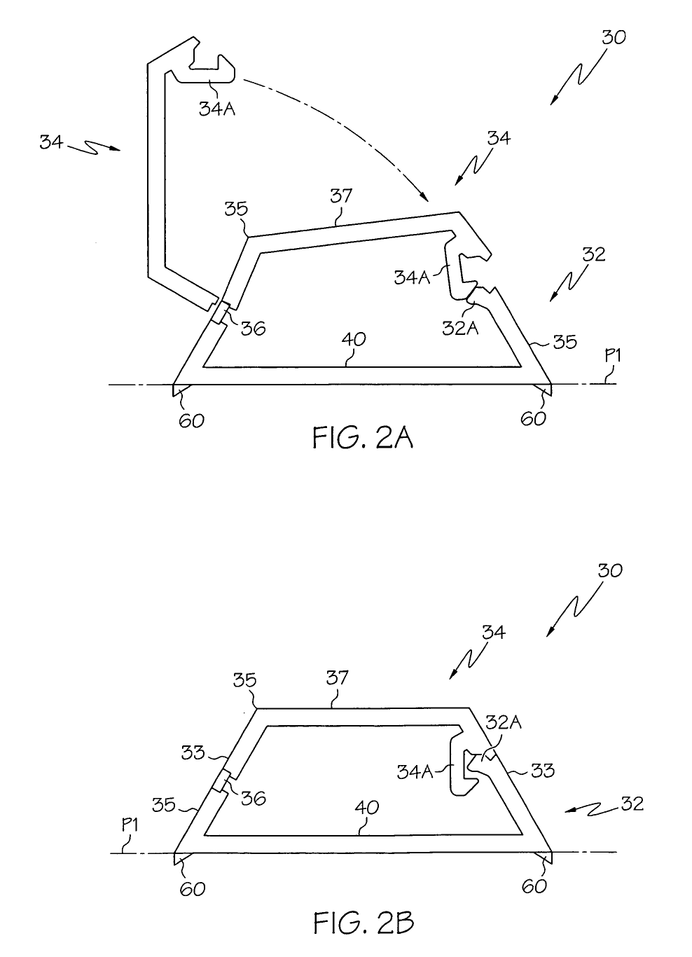

The set portion 32 of construction components according to the present invention typically defines a base plane P1 configured to engage the panel forming slab 10 or some other panel forming surface. The hinge 36 couples the set portion 32 and the hinged portion 34 such that the hinged portion 34 is movable about the hinge 36 between an engaged state and a disengaged state. Referring for example to FIG. 2A, the hinged portion 34 is illustrated at two opposite extremes of disengagement. Traveling along the direction indicated in FIG. 2A, the hinged portion is first illustrated in a substantially disengaged state, where respective engagement portions 32A, 34A of the set portion 32 and the hinged portion 34 are spaced a substantial distance apart along an arc defined about the hinge 36. The hinged portion 34 is also illustrated in a nearly engaged state at the opposite end of the directional arrow present in FIG. 2A, where the respective engagement portions 32A, 34A abut each other but are not yet engaged. FIG. 2B illustrated the engagement portions 32A, 34A of the engagement in a fully engaged state.

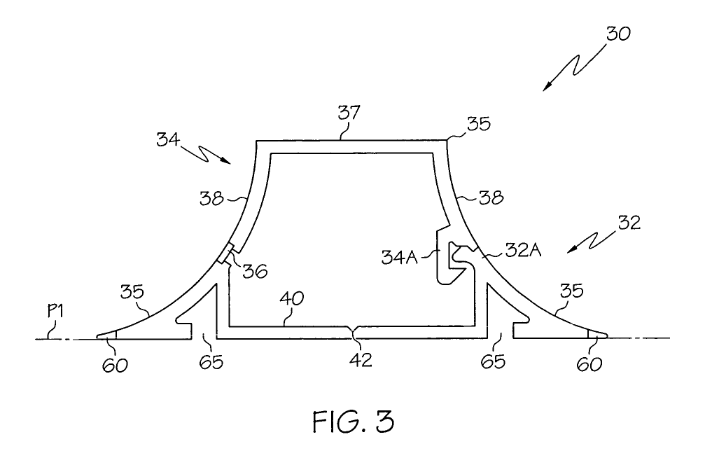

Movement of the hinged portion 34 from the engaged state to a disengaged state reveals a component securing surface 40 of the construction component 30. In this manner, construction components according to the present invention may be conveniently and reliably secured to the panel forming slab 10 or some other panel forming surface by first ensuring that the hinged portion 34 is disengaged and the component securing surface 40 is accessible. Next, a screw, nail, or other securing member is driven through the securing surface 40 into the slab 10. A securement notch 42 is illustrated in FIG. 3 as an example of a convenient means for facilitating accurate positioning and reliable driving of the securing member. Finally, the engagement portions 32A, 32B are placed into the fully engaged state and the construction component 30 is ready for operation.

The set portion 32, hinged portion 34, and hinge 36 define integral portions of the extruded cross-sectional profile of construction components 30 according to the present invention. To facilitate reliable and repeatable movement of the hinged portion 34 about the hinge 36, the hinge 36 is formed of a material that is substantially less rigid than that of the set portion 32 and the hinged portion 34.

As will be appreciated from the description of the various embodiments below, the set portion 32 and the hinged portion 34 will interface along the panel forming face 35 at the engagement defined by the engagement portions 32A, 32B, at the hinge 36, or at both the hinge and the engagement.

The panel forming faces 35 contemplated by the present invention will typically comprise at least one profiled portion 50 defined therein that provided access to a component securing surface 40. The particular shape of the profiled portion 50 may comprise a beveled portion, a vertical or horizontal linear portion, an inwardly curved portion, an outwardly curved portion, or combinations thereof. Profiled portions 50 according to the present invention may be formed from set portions 32 and hinged portions 34, individually or collectively.

Referring specifically to the embodiments of the present invention illustrated in FIGS. 2A and 2B, it is noted that the set portion 32 and the hinged portion 34 can be configured to define the panel forming face 35 substantially entirely. In FIGS. 2A and 2B, the panel forming face 35 comprises a profiled portion 50 including a pair of beveled edges 33 linked by a substantially planar face portion 37 extending there between. The hinged portion 34 provides access to the component securing surface 40 and defines at least a portion of the substantially planar face portion 37.

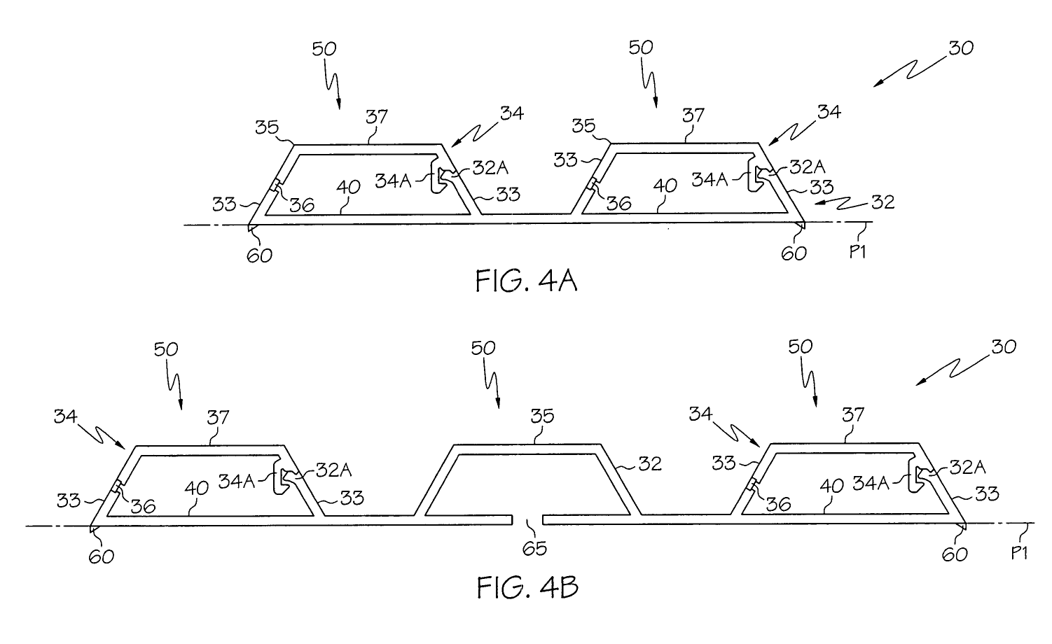

In the embodiments of FIGS. 4A and 4B, the panel forming face 35 comprises a plurality of profiled portions 50, each comprising a pair of beveled edges 33. Selected profiled portions 50 are provided with hinged portions 34 providing access to a component securing surface 40.

Turning to the embodiment of the present invention illustrated in FIG. 3, the panel forming face 35 comprises a single profiled portion 50 including a pair of inwardly curved edge portions 38 linked by a substantially planar face portion 37 extending there between. The hinged portion 34 of the construction component 30 illustrated in FIG. 3 provides access to a component securing surface 40 and defines at least a portion of the substantially planar face portion 37 linking the inwardly curved edge portions 38.

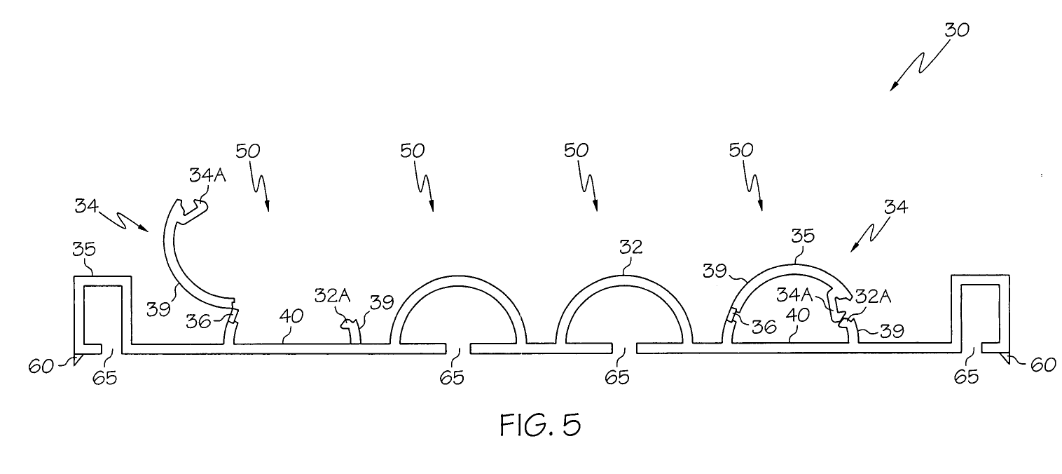

Additional profiled portions 50 according to the present invention are illustrated in FIG. 5. Specifically, the profiled portions 50 illustrated in FIG. 5 comprise a pair of outwardly curved edges 39. The hinged portion 34 of the construction component 30 provides access to the component securing surface 40 and defines at least a portion of the outwardly curved edges 39.

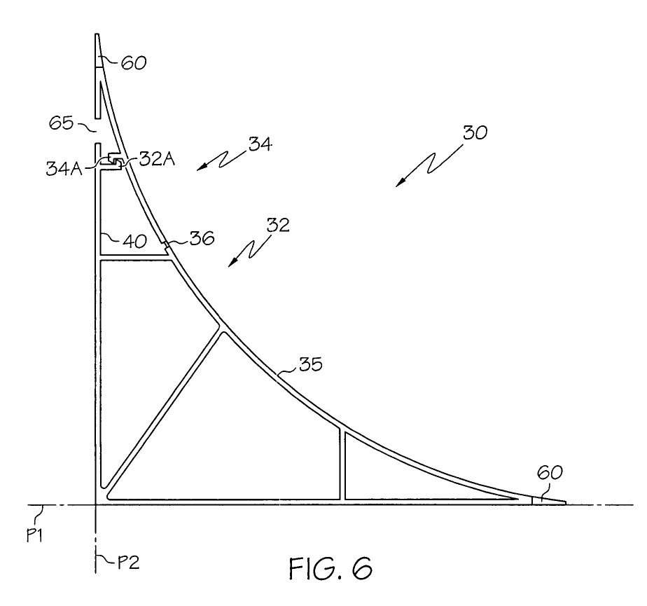

In the embodiment illustrated in FIG. 6, the panel forming face 35 defines a corner chamfer configured such that un-cured material may be cured against and subsequently released from the panel forming face 35 to define a cured panel comprising a chamfered corner formed therein. The corner chamfer illustrated in FIG. 6 defines an inwardly curved panel forming face 35. However, it is contemplated that corner chamfers according to the present invention may be configured to incorporate a variety of profiles including, but not limited to, a beveled portion, an inwardly curved portion, an outwardly curved portion, or combinations thereof. In any case, the hinged portion 34 illustrated in FIG. 6 provides access to a component securing surface 40 that can be aligned along a bulkhead 20, a panel forming slab 10, or another suitable panel forming surface.

Referring collectively to FIGS. 2-6, it is noted that the present invention also relates to the provision of pliant sealing edges 60 extending along the longitudinal dimension of the construction component 30, at one or more of its lateral edges. Pliant sealing edges 60 according to the present invention can be configured to extend beyond or along one or more relatively rigid contact planes P1, P2 defined by the extruded cross-sectional profile of the component. For the purposes of defining and describing the present invention, it is noted that the contact planes P1, P2 are referred to herein as being relatively rigid because they are defined by the relatively rigid material of the component 30, as opposed to the relatively pliant material of the sealing edge 60 and hinge 36.

Where a pliant sealing edge 60 is configured to extend beyond a particular contact plane P1, P2, it is contemplated that it may be preferable to ensure that the sealing edge extends at least about 1/32″ (0.75 mm) beyond the plane. Similarly, where a pliant sealing edges 60 is configured to extend along a particular contact plane P1, P2, it is contemplated that it may be preferable to ensure that the sealing edge extends along the plane for at least about ⅛″ (3 mm).

The pliant sealing edges 60 and the panel forming face 35 define integral portions of the extruded cross-sectional profile and are formed of materials characterized by substantially different degrees of structural rigidity. In this manner, material forming the pliant sealing edge 60 is substantially less rigid than material forming the panel forming face 35. As a result, construction components 30 according to the present invention maintain a high degree of structural integrity because the panel forming face 35 is substantially rigid. In addition, construction components 30 according to the present invention are characterized by enhanced functionality because the pliant sealing edges 60 incorporated therein provide for enhanced sealing properties, particularly where they interface with slabs 10 or bulkheads 20 of inconsistent quality.

For example, a construction component 30 that is substantially linear along its longitudinal dimension may be limited to some extent in its ability to interface with a panel forming slab 10 including slight undulations or irregularities in its surface. By providing a pliant sealing edge 60 at one or more lateral edges of the component 30, the ability of the component to vary from a substantially linear orientation along the longitudinal axis of the component 30 at the lateral edge is enhanced. In addition, pliant sealing edges 60 also help account for instances where variations in the longitudinal linearity of the component 30 would allow un-cured material to seep beyond the bounds defined by the construction component 30.

FIGS. 3, 4B, and 5 illustrate an additional feature of the present invention. Specifically, each of the components 30 illustrated includes an extruded cross-sectional profile that defines a relatively rigid contact plane P1 beyond which the pliant sealing edge 60 is configured to extend. A structural discontinuity 65 is defined in the contact plane P1 and is configured to allow distortion of the contact plane P1 under pressure applied to the pliant sealing edge 60. As a result, the degree to which the lateral edge can vary from a substantially linear orientation along the longitudinal axis of the component 30 is enhanced and the construction component 30 can interface with irregular surfaces with more reliability.

Construction components according to the present invention are typically formed from a plastic material, e.g., polyvinyl chloride (PVC), low or high-density polyethylene or polypropylene, acrylics, polycarbonates, thermoplastic elastomers, etc. Because the construction components according to the present invention include relatively rigid and relatively pliant materials, they may be fabricated by generating a co-extrusion defining a cross section including relatively rigid portions and relatively pliant portions. The relatively pliant portions may be extruded using softer plastics like soft, flexible thermoplastic elastomers, or other relatively soft materials.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise a construction component according to the present invention or a panel forming system incorporating a construction component according to the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A device comprising a construction component, said construction component comprising a set portion, a hinged portion, and a hinge, wherein:
said construction component defines an extruded cross-sectional profile;
said extruded cross-sectional profile defines a panel forming face configured such that an un-cured material may be cured against and subsequently released from said panel forming face in a substantially unobstructed manner;
said set portion defines a base plane, at least a portion of which is configured to engage a panel forming surface;
said set portion and said hinged portion are configured to define an engagement;
said hinge couples said set portion and said hinged portion such that said hinged portion is movable about said hinge between an engaged state and a disengaged state; and
said set portion and said hinged portion cooperate to define at least a portion of said panel forming face.

2. A device as claimed in claim 1 wherein said construction component is configured such that movement of said hinged portion from said engaged state to said disengaged state reveals a component securing surface of said construction component.

3. A device as claimed in claim 1 wherein said panel forming face comprises at least one profiled portion defining a panel forming face comprising a beveled portion, an inwardly curved portion, an outwardly curved portion, or combinations thereof.

4. A device as claimed in claim 3 wherein said panel forming face comprises at least one profiled portion and said hinged portion of said construction component defines at least a portion of said profiled portion.

5. A device as claimed in claim 3 wherein said panel forming face comprises at least one profiled portion and said set portion of said construction component defines at least a portion of said profiled portion.

6. A device as claimed in claim 3 wherein said panel forming face comprises at least one profiled portion and said hinged and set portions of said construction component define at least a portion of said profiled portion.

7. A device as claimed in claim 1 wherein said set portion and said hinged portion define said panel forming face substantially entirely.

8. A device as claimed in claim 1 wherein:
said panel forming face comprises at least one profiled portion; and
said profiled portion comprises a pair of beveled edges.

9. A device as claimed in claim 8 wherein said panel forming face comprises a plurality of profiled portions, each comprising a pair of beveled edges.

10. A device as claimed in claim 8 wherein said beveled edges are linked by a substantially planar face portion extending there between.

11. A device as claimed in claim 10 wherein said hinged portion of said construction component defines at least a portion of said substantially planar face portion linking said beveled edges.

12. A device as claimed in claim 1 wherein:
said panel forming face comprises at least one profiled portion; and
said profiled portion comprises a pair of inwardly curved edge portions.

13. A device as claimed in claim 12 wherein said inwardly curved edge portions are linked by a substantially planar face portion extending there between.

14. A device as claimed in claim 13 wherein said hinged portion of said construction component defines at least a portion of said substantially planar face portion linking said inwardly curved edge portions.

15. A device as claimed in claim 1 wherein:
said panel forming face comprises at least one profiled portion; and
said profiled portion comprises a pair of outwardly curved edge portions.

16. A device as claimed in claim 15 wherein said hinged portion of said construction component defines at least a portion of said outwardly curved edge portions.

17. A device as claimed in claim 1 wherein said panel forming face defines a corner chamfer configured such that un-cured material may be cured against and subsequently released from said panel forming face to define a cured panel comprising a chamfered corner formed therein.

18. A device as claimed in claim 17 wherein said corner chamfer defines a panel forming face comprising a beveled portion, an inwardly curved portion, an outwardly curved portion, or combinations thereof.

19. A device as claimed in claim 1 wherein said set portion and said hinged portion interface along said panel forming face.

20. A device as claimed in claim 1 wherein said set portion and said hinged portion interface along said panel forming face at said engagement.

21. A device as claimed in claim 1 wherein said set portion and said hinged portion interface along said panel forming face at said hinge.

22. A device as claimed in claim 1 wherein said set portion and said hinged portion interface along said panel forming face at said hinge and said engagement.

23. A device as claimed in claim 1 wherein:
said panel forming face defines a pair of lateral edges extending along a longitudinal dimension of said construction component;
at least one of said lateral edges incorporates a pliant sealing edge extending along said longitudinal dimension of said construction component;
said pliant sealing edge and said panel forming face define integral portions of said extruded cross-sectional profile and are formed of materials characterized by substantially different degrees of structural rigidity such that material forming said pliant sealing edge is substantially less rigid than material forming said panel forming face.

24. A device as claimed in claim 1 wherein:
said extruded cross-sectional profile defines at least one relatively rigid contact plane;
said pliant sealing edge is configured to extend beyond or along said relatively rigid contact plane;
said extruded cross-sectional profile defines at least one structural discontinuity in said relatively rigid contact plane associated with said pliant sealing edge; and
said structural discontinuity in said relatively rigid contact plane is configured to allow distortion of said contact plane under pressure applied to said pliant sealing edge.

25. A device as claimed in claim 1 wherein said extruded cross-sectional profile defines said panel forming face and a single, relatively rigid contact plane.

26. A device as claimed in claim 25 wherein:
each of said lateral edges incorporates a pliant sealing edge extending along said longitudinal dimension of said construction component; and
each of said pliant sealing edges are configured to extend beyond or along said single contact plane.

27. A device as claimed in claim 26 wherein each of said pliant sealing edges are configured to extend beyond said single contact plane by at least about 1/32″ (0.75 mm).

28. A device as claimed in claim 26 wherein each of said pliant sealing edges are configured to extend along said single, relatively rigid contact plane by at least about ⅛″ (3 mm).

29. A device as claimed in claim 1 wherein said extruded cross-sectional profile defines a pair of substantially orthogonal, relatively rigid contact planes.

30. A device as claimed in claim 29 wherein said pliant sealing edge is configured to extend beyond or along one of said pair of substantially orthogonal, relatively rigid contact planes.

31. A device as claimed in claim 29 wherein:
each of said lateral edges incorporates a pliant sealing edge extending along said longitudinal dimension of said construction component; and
respective pliant sealing edges are configured to extend beyond or along each of said pair of substantially orthogonal, relatively rigid contact planes.

32. A device as claimed in claim 29 wherein:
said extruded cross-sectional profile defines at least one relatively rigid contact plane;
said pliant sealing edge is configured to extend beyond or along said relatively rigid contact plane;
said extruded cross-sectional profile defines at least one structural discontinuity in said relatively rigid contact plane associated with said pliant sealing edge; and
said structural discontinuity in said relatively rigid contact plane is configured to allow distortion of said contact plane under pressure applied to said pliant sealing edge.

33. A device as claimed in claim 1 wherein:
said device comprises a plurality of components in addition to said construction component; and
said additional components and said construction component are configured as a panel forming system such that said un-cured material can be contained within said panel forming system in the shape of a panel.

34. A device as claimed in claim 33 wherein said plurality of additional components comprise a panel forming slab and a plurality of panel forming bulkheads.

35. A device as claimed in claim 34 wherein said construction component comprises a profiled supplemental panel form.

36. A device as claimed in claim 34 wherein said construction component comprises a corner chamfer.

37. A device as claimed in claim 34 wherein said construction component comprises a rustication.

38. A device comprising a construction component, said construction component comprising a set portion, a hinged portion, and a hinge, wherein:
said construction component defines an extruded cross-sectional profile;
said extruded cross-sectional profile defines a panel forming face configured such that an un-cured material may be cured against and subsequently released from said panel forming face in a substantially unobstructed manner;
said panel forming face comprises at least one profiled portion defining a panel forming face comprising a beveled portion, an inwardly curved portion, an outwardly curved portion, or combinations thereof;
said panel forming face defines a pair of lateral edges extending along a longitudinal dimension of said construction component;
at least one of said lateral edges incorporates a pliant sealing edge extending along said longitudinal dimension of said construction component;
said pliant sealing edge and said panel forming face define integral portions of said extruded cross-sectional profile and are formed of materials characterized by substantially different degrees of structural rigidity such that material forming said pliant sealing edge is substantially less rigid than material forming said panel forming face;
said set portion defines a base plane, at least a portion of which is configured to engage a panel forming surface;
said set portion and said hinged portion are configured to define an engagement and interface along said panel forming face at said hinge and said engagement;
said hinge couples said set portion and said hinged portion such that said hinged portion is movable about said hinge between an engaged state and a disengaged state; and
said construction component is configured such that movement of said hinged portion from said engaged state to said disengaged state reveals a component securing surface of said construction component.
